(19) United States
(12) Patent Application Publication
(10) Pub. No.: US 2016/0273474 A1
(43) Pub. Date: Sep. 22, 2016

(54) METHOD FOR OPERATING AN INTERNAL COMBUSTION ENGINE

(71) Applicant: VOLKSWAGEN AKTIENGESELLSCHAFT, Wolfsburg (DE)

(72) Inventors: MARTIN BIENER, VELTHEIM/OHE (DE); HOLGER BECKER, HOLLE (DE); KAI HARTEL, LEHRTE (DE); FLORIAN FISCHER, BRAUNSCHWEIG (DE); STEFAN LIESKE, WOLFENBUETTEL (DE); FALKO RUDOLPH, BRAUNSCHWEIG (DE)

(73) Assignee: VOLKSWAGEN AKTIENGESELLSCHAFT, Wolfsburg (DE)

(21) Appl. No.: 15/030,968

(22) PCT Filed: Jul. 2, 2014
(86) PCT No.: PCT/EP2014/064016

§ 371 Date: Apr. 21, 2016

(30) Foreign Application Priority Data
Oct. 21, 2013 (DE) 102013221242.9

(51) Int. Cl. F02D 41/24

(52) U.S. Cl. CPC F02D 41/2435

(57) ABSTRACT

A method for operating an internal combustion engine, wherein a valve of a cylinder is opened by a cam of a camshaft within a duty cycle of the engine, and a specified quantity of fuel is supplied to the cylinder. A dimension of the cam and/or a position of the cam on the camshaft is measured after the cam and/or the camshaft has been produced. The dimension, position, and/or a characteristic variable ascertained therefrom is stored, and the quantity of the fuel to be fed within the duty cycle is determined dependent on the stored dimension, position, and/or characteristic variable calculated therefrom. An internal combustion engine is also described for carrying out the method according to the invention.

The invention concerns a method for operating an internal combustion engine in which, within a duty cycle of the engine, a valve of a cylinder is opened by a cam of a camshaft and a predefined quantity of fuel is supplied to the cylinder. The invention furthermore comprises an internal combustion engine which can be operated according to the method of the invention.

The camshaft of a conventional internal combustion engine is driven by the crankshaft, with half its rotation speed, via a fixed connection. In camshaft drives without an adjustment facility, the valve opening times for the valves of the valve gear which are opened by the cams of the camshaft are determined by design. The possibilities for control and intervention are limited in such valve gears.

Therefore various methods have been developed for adjusting the cams. A variable cam adjustment or variable valve control allows the timing of the valve control to be modified as required. This allows an increase in engine efficiency, due firstly to a gain in torque depending on the respective load and secondly to fuel saving. For example, methods are known for adapting the overlap on four-stroke engines, by means of which the time for which the inlet and exhaust valves are open simultaneously can be influenced. To this end, one or more phase adjusters may be provided. Other methods are known in which the crankshaft and camshaft are adjusted relative to each other, whereby the timing can be changed as required. Methods are also known in which the maximum valve lift can be varied, in some cases steplessly.

It has however been found that despite the use of these known methods for camshaft adjustment, there is still room for optimization in the valve control of known internal combustion engines. In particular, in engines with conventional valve control, the individual cylinders often have differing combustion behavior and consequently differing performance and emission behavior, which is connected with increased fuel consumption.

In view of the problems described, the object of the present invention is to refine a method for operating an internal combustion engine by optimizing the valve control such that the engine can be operated particularly optimized for emissions and consumption.

This object is achieved by a refinement of the method described, which is essentially characterized in that a dimension of the cam and/or a position of the cam on the camshaft is measured after production of the cam and/or camshaft, the dimension, position and/or a characteristic value determined therefrom is stored, and the quantity of fuel to be supplied within the duty cycle is determined depending on the stored dimension, position and/or characteristic value determined therefrom.

The invention is based on the knowledge that in the production of cams for operation of gas exchange valves, there are variations in the cam contours produced. The variations lead to differences in the valve lift course of the gas exchange valves operated by the cams. For example, a cam protruding far—within the limits of production tolerance—in the transverse direction of the camshaft leads to a longer valve opening time then a cam protruding less far within the limits of production tolerance.

In addition, the individual cams of a camshaft are regularly attached to a cam carrier shaft in the form of separate cam elements such as cam discs or similar. To this end, the individual cam elements are pressed onto the cam carrier shaft and joined thereto in a predefined rotary position and axial position, wherein however due to production, on fixing, deviations of the actual rotary position of the individual cam elements from the proposed rotary position can often result. A different rotary position leads to a shift in the valve opening window, and hence to a different gas flow behavior. Finally, therefore, the fresh gas quantity supplied to a cylinder per working cycle also depends on the rotary position in which the associated cam is attached to the camshaft.

According to the invention, the fuel injection quantity per duty cycle is adapted to this fresh gas filling, which differs depending on the actual cam arrangement, in that a dimension of the cam and/or a position of the cam on the camshaft is measured and stored after production of the cam and/or camshaft. Alternatively, a characteristic value, determined from the dimension and/or position of the cam, may be stored which characterizes the cam-specific valve lift, and/or another value which is a measure of the gas quantity flowing into or out of the combustion chamber per valve stroke under predefined peripheral conditions. Alternatively or additionally, the characteristic value may indicate a time and/or a time window of the valve opening, or a valve opening course. This characteristic value or plurality of characteristic values may be determined from the measured dimension and/or position of the cam or be calculated from further characteristic values or engine parameters.

The quantity of fuel to be supplied within a duty cycle may now be determined as a function of the dimension, position and/or characteristic value(s) calculated therefrom. This means that for the cylinder, the fuel quantity to be supplied within a duty cycle is adapted to the actual valve lift and the actual fresh gas quantity supplied, whereby the combustion behavior and hence also the emission behavior are optimized for the corresponding cylinder.

The valve activated by the cam is not necessarily an inlet valve but may also be an exhaust valve of the cylinder. The fuel quantity to be supplied optimally within a duty cycle may in fact also depend on the opening curve of one or more exhaust valves of the cylinder.

The internal combustion engine may be a diesel, petrol or other internal combustion engine with an arbitrary number of cylinders. Preferably, the engine is a four-stroke petrol engine. The invention is not however restricted to these engine types. Preferably, the fuel is injected directly into the cylinder, the method according to the invention is however also usable in engines in which fuel is supplied upstream of the inlet valve.

The advantages of the invention described above are particularly applicable if a dimension and/or position, in particular a rotary position in the circumferential direction, of two or more, in particular of all cams of the camshaft, is measured after their production; the dimensions, positions and/or valve lift characteristic values determined therefrom for the individual cams are stored; and the quantity of fuel supplied per duty cycle to two or more cylinders, to each of which a cam is assigned, is determined as a function of the dimension, position and/or characteristic value determined therefrom of the cam assigned to the respective cylinder.

The problems described initially of conventional internal combustion engines result in particular from the fact that, because of different contours and/or different rotary positions of the cams of a camshaft, the individual cylinders of the engine per duty cycle are supplied with different quantities of fresh gas but uniform quantities of fuel, wherein these fuel quantities are not adapted to the differences in the fresh gas quantities of the individual cylinders. This can lead to a different combustion behavior and emission behavior in the individual combustion chambers, even if an inflowing total gas quantity across all cylinders is measured by means of a sensor and the injection quantity across all cylinders adapted thereto. If however the injection quantity is adapted cam-specifically to the respective contour and/or position of the cam, the fuel consumption and emissions can be lowered further and the true running of the engine improved.

As a whole therefore, the filling of the individual cylinders is detected more specifically and the fuel is injected cylinder-specifically. The fuel injection and combustion are then optimized for emissions and fuel consumption.

Preferably, on operation of the internal combustion engine, the respective determined quantity of fuel is injected into the individual cylinders per duty cycle. Naturally, the method described initially for variable valve control can also be used to further optimize the valve timing.

When measuring the cam, it has proved advantageous to use a measuring process of which the measuring error is less than the variation within the limit of the predefined tolerance for the camshaft production. The more precisely the cam contour and cam position are measured, the more accurately the injection quantity of the fuel can be adapted thereto, which leads to an improved combustion behavior for each individual cylinder. The step of measuring the cams is preferably carried out following the fixing of the individual cams to the camshaft, so that the rotary position, or its deviation from a proposed rotary position of the individual cams, in the circumferential direction can be measured.

It has proved suitable if, on production of the camshaft, one or more cams are attached to a cam carrier shaft, wherein the rotary position of the one or more cams in the circumferential direction of the cam carrier shaft is measured after production. The individual cam elements which each carry one or more cams are here joined to the cam carrier shaft preferably by press fit. The deviation of the actual rotary position from the proposed rotary position is great with this production method, so the method according to the invention brings substantial improvements in terms of true running and combustion behavior of the engine.

Alternatively or additionally, a dimension of the cam in the radial direction, a dimension of the cam in the circumferential direction of the camshaft axis, and/or a course of the camshaft running face can be measured. These values also have an effect on the valve lift, in particular on the valve opening duration and the valve opening time. Alternatively or additionally, the axial position of the cam on the camshaft and/or the mutual position of the individual cams of the camshaft may be measured.

Then a cam-specific valve lift characteristic value or plurality of valve lift characteristic values can be determined from the values measured.

To this end, preferably in a control unit of the engine, an allocation is stored which assigns fuel injection quantities to the predefined valve lift characteristic values, wherein the control unit compares the valve lift characteristic value previously determined with the allocation, and from this the quantity of fuel to be supplied per duty cycle is determined preferably cylinder-individually.

Normally, engine control units contain previously determined or calculated data sets which specify the quantities of fuel to be injected as a function of specific engine characteristic values. For example, these data sets may specify injection quantities as a function of rotation speed, load, an aspirated total air quantity, temperature, throttle valve position etc. According to the invention, these data sets also indicate the proposed injection quantity as a function of the measured dimension and/or position, in particular the rotary position, in which the cam is attached to the camshaft, or the characteristic values determined therefrom.

Since the production-defined rotary positions and dimensions of the individual cams of the camshaft do not change after production during operation of the internal combustion engine, after production of the engine a single allocation process may be provided which activates an injection quantity map in the engine control unit to be used for future operation of the engine, so that in future the fuel is injected correctly per individual cylinder as a function of the cam dimensions. In this case, the comparison described above of the actual valve lift characteristic value with the allocation is only performed once following installation of the engine.

According to a further aspect of the invention, it has proved advantageous that the dimension and/or position of the cam determined by measurement is stored in the form of an optically readable code such as a data matrix code (DMC) or a bar code. The optically readable code can later be read by a read device such as a scanner and transferred to a database or memory. For example, the rotary position measured for each cam of a camshaft can be stored in the form of a separate DMC, and/or a single DMC can be produced which indicates the rotary positions of all cams of a camshaft. Storage may take the form that the optically readable code, in particular the DMC, is permanently written by means of laser, needle engraving or similar to the cams, the camshaft, a cover module or another engine component. Alternatively, the DMC can be attached to a component of the engine by means of a label or similar, so that later correct allocation to the measured cams is possible at any time. When the cam or camshaft is installed in the engine or at a later time, the content of the DMCs can be read by a scanner and transferred to a suitable control unit such as the engine control unit, a database and/or a memory. Optically readable codes are particularly suitable for permanently attaching information to a component, and can easily be read at any time later by means of a scanner. A DMC is suitable for storage of a particularly large quantity of information and is particularly reliable because of the error correction methods used therein.

Storage of previously measured characteristic curves of a vehicle in the form of optically readable codes, such as in the form of data matrix codes, is already known from other publications. For example, publication DE 10 2010 048 126 A1 describes the recording of a clutch characteristic curve and its storage by means of a data matrix code, such that the data matrix code is applied to the clutch system in a readable fashion. This data matrix code can then be read by means of a scanner. Publication DE 10 2011 114 066 A1 describes the application of a label to a dual clutch, wherein the label carries a bar code or a data matrix code which indicates a characteristic curve of the dual clutch.

In contrast, DMCs are used according to the invention to store dimensions and/or positions of engine components, in particular of cams of a camshaft. A method in which, after production of an engine component such as a camshaft, a dimension and/or position of the component is measured and the measured dimension, position and/or a characteristic value calculated therefrom stored by means of a DMC, constitutes a separate aspect of the present invention. By linking the component-specific data to the DMC of the fitted engine, a precise dimension and/or position of the component, such as the actual position of the individual cams of the camshaft, can be taken from the finished assembly. The individual components of the engine are thus individualized according to the invention. Preferably, the DMC is permanently attached to an engine component, in particular at an accessible position, so that later reading is easily possible.

According to a further aspect, the invention concerns an internal combustion engine with at least one camshaft with at least one cam for opening a valve of the cylinder and with an injection device for supplying a predefined quantity of fuel to the cylinder per duty cycle.

To improve the emission values and combustion behavior of the engine, according to the invention a control unit is provided with access to a previously measured dimension and/or position of the cam, and/or to a characteristic value determined therefrom, and with means for establishing the quantity of fuel to be supplied per duty cycle as a function of the position or dimension of the cam and/or the characteristic value determined therefrom. In such an internal combustion engine according to the invention, injection takes place into the individual cylinders in accordance with the actual dimensions and actual rotary position of the cam assigned to the cylinder, so that the engine can be operated particularly optimized for fuel consumption.

The method steps described above may also be implemented similarly in the internal combustion engine according to the invention.

For example, the control unit may determine the quantity of fuel to be supplied for several, in particular all cylinders of the engine as a function of the measured rotary position of the cam assigned to the respective cylinder. The individual cam or an engine component which can be assigned to the cam may comprise a DMC printed thereon or written therein, or another optically readable code, which indicates a dimension and/or an installation position of the cam. The dimensions and/or positions of the cams on the camshaft or characteristic values calculated therefrom may be stored in the engine control unit, a database or a memory to which the engine control unit has access. It is sufficient if this access is permitted once only before first use or delivery of the engine, so that for later operation of the engine, the cylinder-specific injection quantities can be definitively established as a function of the cam configurations.

The invention will now be explained in more detail with reference to an exemplary embodiment shown in the drawings. The drawing shows:

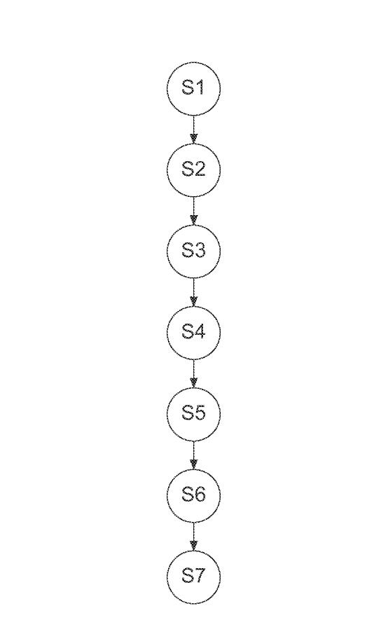

FIG. 1: the sequence of the method according to the invention in the form of a schematic diagram.

At step S1, a cam disc with at least one cam is applied to a camshaft. This step is not necessarily included in the method according to the invention.

After production of the camshaft, the rotary position of the cam on the camshaft is measured in step S2. The step of measurement may in particular comprise determination of a twist angle by which the cam disc is twisted in the circumferential direction starting from a proposed installation position of the cam disc, wherein the proposed installation position may be marked on the cam carrier shaft. In addition, further dimensions of the cam may be measured. The measured values are permanently written to the cam element or another engine component at step S3 in the form of a DMC by means of a laser or similar.

After installation of the camshaft in the engine, the content of the DMC is read at step S4 by means of a scanner or similar, and at step S5 transferred to a control unit which calculates a valve lift characteristic value therefrom. By comparison with an existing allocation, the control unit in step S6 determines, as a function of the valve lift characteristic value, which quantities of fuel must be used in the presence of specific engine parameters. To this end, depending on the valve lift characteristic value, for each cylinder the control unit may activate a specific injection quantity map, the values of which are accessed in later operation of the engine.

On operation of the engine, the fuel is injected at step S7 for each cylinder according to the values of the activated injection quantity map, and hence as a function of the dimensions and/or positions of the cam or all cams of the camshaft.

This method is performed for each cam of the camshaft so that the injection into the individual combustion chambers of the engine takes place cam-specifically.

The method illustrated in FIG. 1 should be regarded as exemplary. The cam positions measured are not necessarily stored by means of the DMC. Furthermore, measurement of the individual cams is also possible before installation on the camshaft. Moreover, a conventional one-piece camshaft may also be measured before installation in the engine.

### LIST OF REFERENCE NUMERALS

S1 Attachment of cam to camshaft

S2 Measurement of rotary position of cam on camshaft

S3 Storage of measurement value by DMC

S4 Reading of DMC by scanner

S5 Transfer of DMC content to engine control unit

S6 Determination of injection quantity

S7 Injection of determined fuel quantity during operation of engine

1-9. (canceled)

10. A method for operating an internal combustion engine in which, within a duty cycle of the engine, a valve of a cylinder is opened by a cam of a camshaft and a predefined quantity of fuel is supplied to the cylinder, the method comprising:
subsequent to a production of the cam and/or the camshaft, measuring at least one parameter selected from the group consisting of a dimension and a position of the cam on the camshaft;
storing at least one of the dimension, the position, or a characteristic value determined therefrom; and
determining the quantity of fuel to be supplied within the duty cycle of the engine in dependence on the stored dimension, position and/or characteristic value determined therefrom.

11. The method according to claim 10, which comprises:
measuring the dimension and/or position of two or more cams of the camshaft subsequent to a production of the cams;
storing the dimensions, positions and/or valve lift characteristic values determined therefrom for each individual cams; and
determining the quantity of fuel supplied per duty cycle to two or more cylinders, to each of which a cam of the camshaft is assigned, as a function of the dimension, position and/or characteristic value determined therefrom of the cam assigned to the respective cylinder.

12. The method according to claim 11, which comprises measuring the dimension and/or position of all cams of the camshaft.

13. The method according to claim 10, which comprises, during an operation of the internal combustion engine, injecting the respectively determined quantity of fuel into the individual cylinders per duty cycle.

14. The method according to claim 10, wherein the measuring step comprises measuring the dimension and/or position of the cam with a measuring process having a measuring error less than a variation within limits of a predefined tolerance for the camshaft production.

15. The method according to claim 10, wherein the measuring step comprises measuring the dimension and/or position of the cam by way of laser technology.

16. The method according to claim 10, which comprises, on production of the camshaft, attaching one or more cams to a cam carrier shaft, measuring a rotational position of the one or more cams in a circumferential direction of the cam carrier shaft and determining therefrom a cam-specific valve lift characteristic value.

17. The method according to claim 16, which comprises carrying out an allocation that assigns fuel injection quantities to predefined valve lift characteristic values, comparing the valve lift characteristic value with the allocation, and determining from the comparison the quantity of fuel to be supplied per duty cycle.

18. The method according to claim 17, which comprises determining the quantity of fuel to be supplied per duty cycle cylinder-specifically.

19. The method according to claim 10, wherein storing step comprises storing the dimension and/or position of the cam determined by measurement in the form of an optically readable code to be read subsequently.

20. The method according to claim 19, wherein the optically readable code is a data matrix code.

21. An internal combustion engine, comprising:
a camshaft with at least one cam for opening a valve of a cylinder;
an injection device for supplying a predefined quantity of fuel to the cylinder per duty cycle;
a control unit having access to at least one previously measured parameter selected from the group consisting of a position of the cam, a dimension of the cam, and a characteristic value determined therefrom, and being configured to establish the quantity of fuel to be supplied per duty cycle as a function of the at least one previously measured parameter.

22. The internal combustion engine according to claim 17, which comprises an optically readable code permanently applied to a component of the engine, the optically readable code indicating the at least one previously measured parameter selected from the group consisting of a position of the cam, a dimension of the cam, and a characteristic value determined therefrom for at least one cam of the camshaft.

23. The internal combustion engine according to claim 22, wherein the optically readable code is a data matrix code.

24. An internal combustion engine, comprising a camshaft with at least one cam, and an optically readable code permanently applied to a component of the engine, the optically readable code indicating a previously measured parameter selected from the group consisting of a position of the cam, a dimension of the cam, and a characteristic value determined therefrom for the at least one cam of the camshaft.

25. The internal combustion engine according to claim 24, wherein the optically readable code is a data matrix code.
